(19) United States
(12) Patent Application Publication
(10) Pub. No.: US 2026/0138630 A1
(43) Pub. Date: May 21, 2026

(54) LANE DEPARTURE PREVENTION DEVICE

(71) Applicant: TOYOTA JIDOSHA KABUSHIKI KAISHA, Toyota-shi (JP)

(72) Inventor: Hikaru AKIMOTO, Mishima-shi (JP)

(73) Assignee: TOYOTA JIDOSHA KABUSHIKI KAISHA, Toyota-shi (JP)

(21) Appl. No.: 19/369,997

(22) Filed: Oct. 27, 2025

(30) Foreign Application Priority Data
Nov. 15, 2024 (JP) 2024-199377

(51) Int. Cl. B60W 50/12; B60W 30/12; B60W 50/00

(52) U.S. Cl. CPC B60W 50/12; B60W 30/12; B60W 2050/0083; B60W 2510/202; B60W 2554/4045

(57) ABSTRACT

A lane departure prevention device performs a "lane departure prevention operation of automatically steering a steered wheel such that a host vehicle does not depart from a host lane" when a "start condition that is predetermined is satisfied, the start condition being satisfied when there is a possibility that the host vehicle departs from the host lane". The lane departure prevention device determines whether a "specific condition is satisfied, the specific condition being satisfied when there is a possibility that a moving object jumps into the host lane from outside the host lane". In a case where determination is made that the specific condition is satisfied, the lane departure prevention device does not perform the lane departure prevention operation even when the start condition is satisfied.

### CROSS-REFERENCE TO RELATED APPLICATION

This application claims priority to Japanese Patent Application No. 2024-199377 filed on November 15, 2024. The disclosure of the above-identified application, including the specification, drawings, and claims, is incorporated by reference herein in its entirety.

### BACKGROUND

### 1. Technical Field

The present disclosure relates to a lane departure prevention device that performs lane departure prevention control for preventing (suppressing) a host vehicle from departing from a host lane that is a lane in which the host vehicle is traveling.

### 2. Description of Related Art

In the related art, a lane departure prevention device may predict that a host vehicle departs from a traveling path (host lane) beyond a boundary of the traveling path. In this case, in a case where an object (for example, a pedestrian) is present outside the boundary, the host vehicle is controlled such that a maximum movement position when the host vehicle moves to a departure side is a "position on a traveling path side with respect to the boundary" (see Japanese Unexamined Patent Application Publication No. 2017-13606 (JP 2017-13606 A)). Accordingly, a contact between the object present outside the boundary and the host vehicle can be avoided.

### SUMMARY

In a case where a driver of a host vehicle recognizes that there is a possibility that a moving object (for example, a pedestrian) jumps out into a lane in which the host vehicle is traveling (that is, a host lane), the driver changes a position of the host vehicle to a position closer to the center of a road on which the host vehicle is traveling. That is, in this case, the driver performs steering such that the host vehicle departs from the host lane to an opposing lane. However, since a lane departure prevention device of the related art performs a lane departure prevention operation (automatic steering) even in such a case, the driver of the host vehicle may feel troubled by the lane departure prevention operation.

The present disclosure is devised in order to solve the issue described above. That is, an object of the present disclosure is to provide a lane departure prevention device in which a possibility of inhibiting an intentional steering operation of a driver in a case as described above is low.

An aspect of a lane departure prevention device according to the present disclosure includes a controller (10) configured to perform a lane departure prevention operation of automatically steering a steered wheel of a host vehicle (step 550) such that the host vehicle does not depart from a host lane, when a start condition that is predetermined is satisfied. The start condition is satisfied when there is a possibility that the host vehicle departs from the host lane (step 510: Yes).

Further, the controller is configured to suppress the lane departure prevention operation (step 390 and step 540: No) when a specific condition is satisfied. The specific condition is satisfied when there is a possibility that a moving object jumps out into the host lane from outside the host lane (step 320, step 330, and step 380). The suppression of the lane departure prevention operation can be performed by not performing the lane departure prevention operation (step 540: No). Further, the suppression of the lane departure prevention operation can be performed by changing an override threshold value to a small value when the specific condition is satisfied (step 640, step 530, step 535, and step 525: No).

According to the aspect, in a case where a driver recognizes that there is a high possibility that a moving object jumps out into a host lane and the driver performs steering such that the host vehicle departs to a center side of a road from the host lane, the steering is less likely to be inhibited by a function of the lane departure prevention device. Accordingly, a possibility that a driver feels troubled by the lane departure prevention operation can be reduced.

In the above description, in order to facilitate understanding of the present disclosure, either or both of names and reference symbols used in embodiments described below are added in parentheses to configurations of the disclosure corresponding to the embodiments. However, each component of the present disclosure is not limited to the embodiment defined by either or both of the name and the reference symbol. The present disclosure also extends to a lane departure prevention method and a program thereof.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a lane departure prevention device according to a first embodiment of the present disclosure;

FIG. 2 is a diagram for describing an operation of the lane departure prevention device shown in FIG. 1;

FIG. 3 is a routine executed by a CPU of a driving assistance ECU shown in FIG. 1 (first embodiment and second embodiment);

FIG. 4 is a routine executed by the CPU of the driving assistance ECU shown in FIG. 1 (first embodiment and second embodiment);

FIG. 5 is a routine executed by the CPU of the driving assistance ECU shown in FIG. 1 (first embodiment and second embodiment); and

FIG. 6 is a routine executed by a CPU of a driving assistance ECU according to a second embodiment of the present disclosure (second embodiment).

### DETAILED DESCRIPTION OF EMBODIMENTS

### First Embodiment

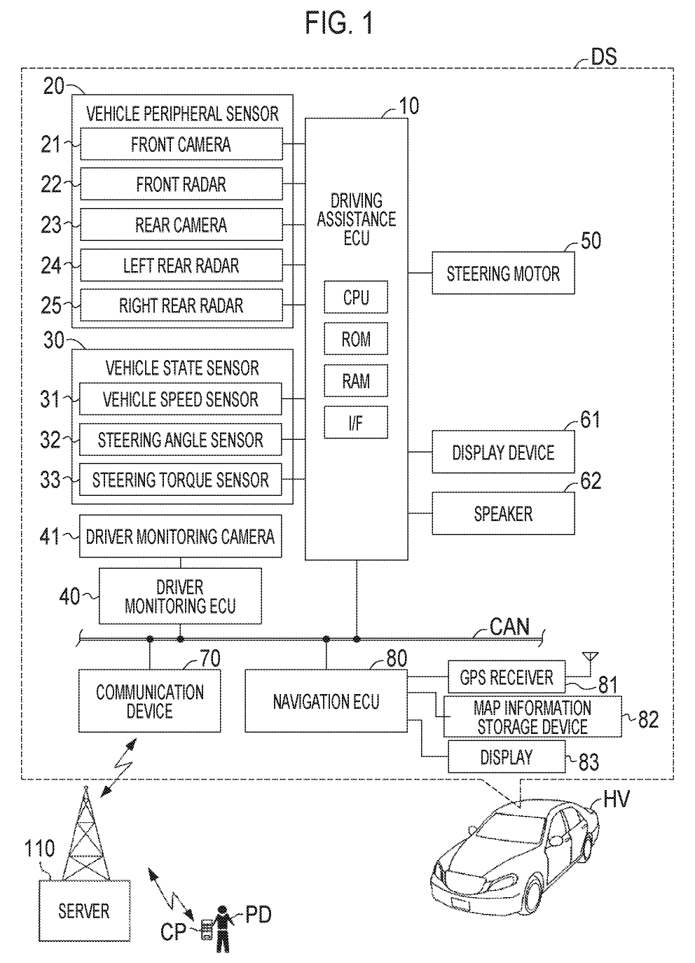

A "lane departure prevention device DS (hereinafter, referred to as a "first device DS") according to a first embodiment of the present disclosure includes components shown in FIG. 1 and is applied (mounted) to a host vehicle HV. The host vehicle HV may be any one of a vehicle having an internal combustion engine as a power source, a vehicle having an electric motor as a power source (that is, a battery electric vehicle), a hybrid electric vehicle, or the like.

In the present specification, an "ECU" is an electronic control device (control unit) including a microcomputer. The microcomputer includes a CPU (processor), a ROM, a RAM, a non-volatile memory to which data can be written, an interface, and the like. The ECU is also referred to as a controller or a computer. A plurality of ECUs shown in FIG. 1 are connected to each other through a controller area network (CAN) such that information can be exchanged. Some or all of the ECUs may be integrated into one ECU.

A driving assistance ECU 10 performs lane departure prevention control to be described later. The driving assistance ECU 10 is connected to components (a camera, a sensor, a switch, an ECU, a device, and the like) to be described below and transmits and receives information or a signal to and from the components. The driving assistance ECU 10 may be composed of a plurality of ECUs.

A vehicle peripheral sensor 20 includes a forward camera 21, a forward radar 22, a rear camera 23, a left rear radar 24, and a right rear radar 25.

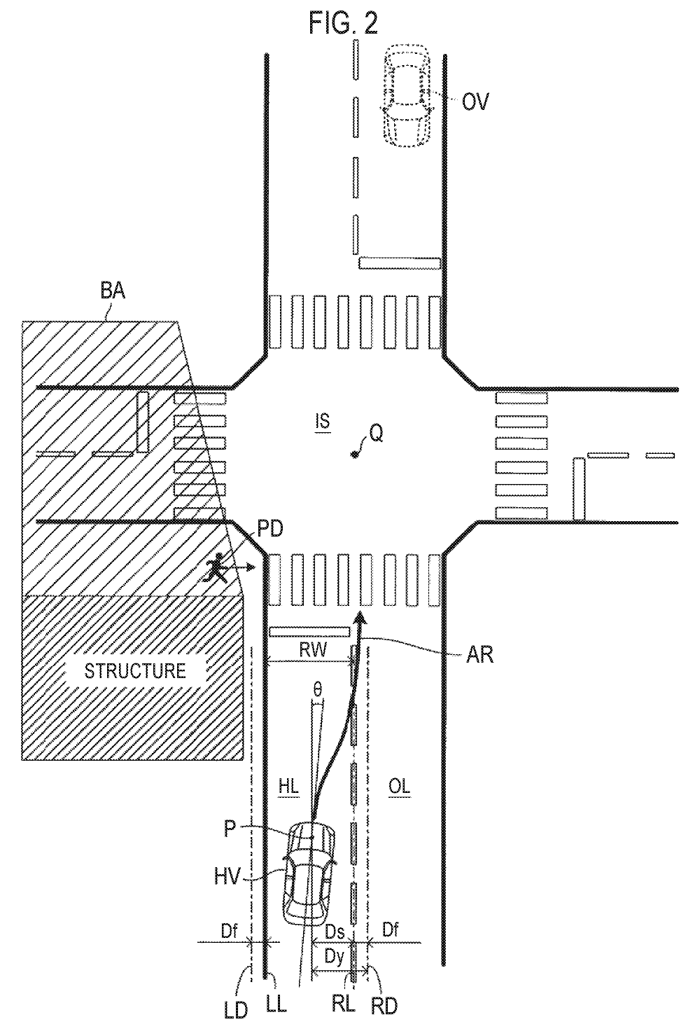

The forward camera 21 captures a scene in front of the host vehicle HV at time intervals that are predetermined to acquire forward image data. The driving assistance ECU 10 recognizes "a left boundary line LL and a right boundary line RL" on a road based on the forward image data (see FIG. 2). The boundary line is a lane dividing line (for example, a white line). A region between the left boundary line LL and the right boundary line RL is a lane (that is, a host lane HL) in which the host vehicle HV is traveling.

Further, the driving assistance ECU 10 can acquire "a lane width RW of the host lane HL, a proximity distance Ds, and a yaw angle θ" shown in FIG. 2 based on the forward image data.

The proximity distance Ds is a distance from a reference point P of the host vehicle HV to a boundary line on a certain side where the host vehicle HV is about to depart from the host lane HL. The reference point P on the host vehicle HV is a center point between a left front wheel and a right front wheel of the host vehicle HV. The certain side where the host vehicle HV is about to depart from the host lane HL is referred to as a "departure side" for convenience.

The yaw angle θ is an angle formed between a direction of the boundary line and a front-rear axis direction of the host vehicle HV (that is, a direction in which the host vehicle HV is oriented).

Further, the driving assistance ECU 10 obtains a sum of the proximity distance Ds and a correction distance Df that is predetermined, as a "departure margin distance Dy (= Ds + Df)". The correction distance Df may be "0", a positive value, or a negative value.

In addition, the driving assistance ECU 10 can acquire information (that is, forward camera object information) about an object located in front of the host vehicle HV based on the forward image data. The forward camera object information includes a position of the object with respect to the host vehicle HV and a type of the object.

The forward radar 22 acquires information (that is, forward radar information) about the object located in front of the host vehicle HV using radio waves in a millimeter wave band. The forward radar information includes a position of the object with respect to the host vehicle HV (that is, a distance between the host vehicle HV and the object and a bearing of the object with the host vehicle HV as a reference) and a relative speed of the object.

The driving assistance ECU 10 integrates the forward camera object information and the forward radar information to generate forward fusion object information.

The rear camera 23 captures a scene behind the host vehicle HV at time intervals that are predetermined to acquire rear image data. The driving assistance ECU 10 acquires information (that is, rear camera object information) about an object located behind the host vehicle HV based on the rear image data. The rear camera object information includes a position of the object with respect to the host vehicle HV and a type of the object.

The left rear radar 24 acquires information (that is, left rear radar information) about the object located behind and on a left rear side of the host vehicle HV using radio waves in a millimeter wave band.

The right rear radar 25 acquires information (that is, right rear radar information) about the object located behind and on a right rear side of the host vehicle HV using radio waves in a millimeter wave band.

The driving assistance ECU 10 integrates the rear camera object information, the left rear radar information, and the right rear radar information to generate rear fusion object information.

A vehicle state sensor 30 includes a vehicle speed sensor 31, a steering angle sensor 32, and a steering torque sensor 33.

The vehicle speed sensor 31 outputs a signal indicating a speed (that is, a host vehicle speed) Vh of the host vehicle HV.

The steering angle sensor 32 outputs a signal indicating a steering angle Sa of the host vehicle HV.

The steering torque sensor 33 outputs a signal indicating a steering torque Tq of the host vehicle HV. The steering torque Tq is a torque applied to a steering mechanism by a driver of the host vehicle HV operating a steering wheel (not shown).

A driver monitoring ECU 40 is connected to a driver monitoring camera 41 that captures an image of a face of the driver of the host vehicle HV at time intervals that are predetermined to acquire face image data. The driver monitoring ECU 40 transmits driver information indicating a state in which the driver drives the host vehicle HV to the driving assistance ECU 10 based on the face image data.

A steering motor 50 drives the steering mechanism (not shown) of the host vehicle HV in response to an instruction from the driving assistance ECU 10 to change a steering angle of the host vehicle HV. That is, the steering motor 50 is driven to steer the steered wheel.

A display device 61 displays a warning indicator that is predetermined. A speaker 62 generates a warning sound.

A communication device 70 communicates with devices (for example, a server 110 on the outside, a communication terminal CP carried by a pedestrian PD, a communication device of other vehicles, a road-side device, and the like) outside the host vehicle HV to acquire various types of information from the devices outside the host vehicle HV. Hereinafter, the pedestrian and a bicycle are referred to as "pedestrian or the like", and the other vehicle and a motorcycle are referred to as "other vehicle or the like". Further, a movable object including the pedestrian or the like and the other vehicle or the like may be referred to as a "moving object".

A navigation ECU 80 is connected to a GPS receiver 81, a map information storage device 82, and a display 83. The navigation ECU 80 estimates a current position of the host vehicle HV based on a GPS signal received by the GPS receiver 81. The map information storage device 82 stores map information. The display 83 displays various types of information.

### Outline of Operation

A first device DS determines a line that is obtained by moving the left boundary line LL by a correction distance Df to an outside (left side) of the host lane HL, as a left departure restriction line LD. The first device DS determines a line that is obtained by moving the right boundary line RL by the correction distance Df to the outside (right side) of the host lane HL, as a right departure restriction line RD. In a case where prediction is made that the host lane HL departs from the left departure restriction line LD to the outside (left side), the first device DS changes a steering angle of the host lane HL such that the host vehicle HV travels in a right direction. In a case where prediction is made that the host lane HL departs from the right departure restriction line RD to the outside (right side), the first device DS changes the steering angle of the host lane HL such that the host vehicle HV travels in a left direction. An operation of changing the steering angle is referred to as a lane departure prevention operation. Control of preventing the host vehicle HV from departing from the host lane HL through the lane departure prevention operation is referred to as lane departure prevention control.

In a case where the driver of the host vehicle HV passes through an intersection IS without a signal, the driver may recognize that there is a possibility that a moving object jumps into the host lane HL is present. In this case, the driver often performs steering such that the host vehicle HV travels while the host vehicle HV is departing from the host lane HL to an opposing lane OL. However, a lane departure prevention device in the related art steers the steered wheel against such steering performed by the driver. For this reason, in a case where the host vehicle HV approaches the "intersection IS in which a traffic light is not provided", the first device DS determines whether a moving object including a pedestrian or the like is present in the vicinity of the intersection IS. In a case where determination is made that the moving object is present, the first device DS determines that there is a possibility that the pedestrian or the like jumps into the host lane HL. In a case where determination is made that there is a possibility that the pedestrian or the like jumps into the host lane HL, the first device temporarily suspends and stops the lane departure prevention control (that is, the lane departure prevention operation). Accordingly, with the first device DS, it is possible to prevent the intentional steering by the driver described above from being inhibited by the lane departure prevention control.

### Specific Operation

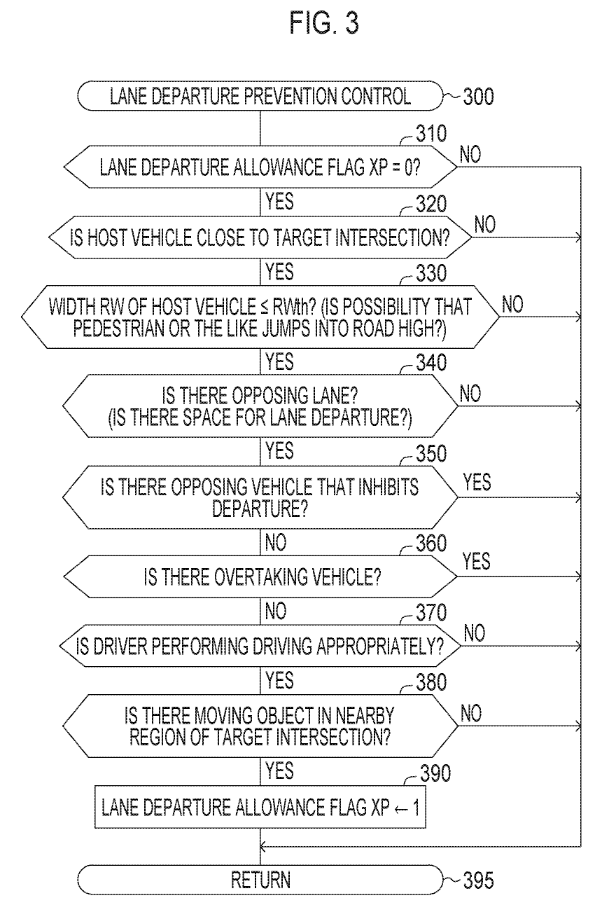

The CPU of the driving assistance ECU 10 executes routines shown in FIGS. 3 to 5 at time intervals that are predetermined. Hereinafter, a "step" is denoted by "S". A value of each flag to be described below is set to "0" in an initialization routine (not shown) executed by the CPU in a case where the host vehicle HV is started.

When a timing that is predetermined is reached, the CPU starts processing from S300 of FIG. 3 to proceed to S310 and determines whether a value of a lane departure allowance flag XP is "0".

In a case where the value of the lane departure allowance flag XP is "0", the CPU proceeds from S310 to S320. The CPU determines whether the host vehicle HV has approached a target intersection based on the host vehicle speed Vh and "the current position of the host vehicle HV and the map information" acquired via the navigation ECU 80. For example, in a case where prediction is made that the host vehicle HV reaches the target intersection within a first time threshold value (for example, 5 seconds), the CPU determines that the host vehicle HV has approached the target intersection. In a case where a distance between the host vehicle HV and the target intersection is within a first distance threshold value, the CPU may determine that the host vehicle HV has approached the target intersection. The target intersection is "the intersection IS that has a blind spot BA with respect to the host vehicle HV and that does not have a traffic light" shown in FIG. 2. The blind spot BA is also a blind spot for the driver of the host vehicle HV.

In a case where determination is made that the host vehicle HV has approached the target intersection, the CPU proceeds from S320 to S330. The CPU determines whether the lane width RW of the host lane HL is equal to or less than a lane width threshold value RWth (for example, 2.5 m) based on forward fusion object information. That is, in S330, the CPU determines whether the host vehicle HV travels on a "road in an urban area in which there is a high possibility that a moving object jumps into the host lane HL".

In a case where the lane width RW is equal to or less than the lane width threshold value RWth, the CPU proceeds from S330 to S340 and determines whether an opposing lane OL is present on a road on which the host vehicle HV is currently traveling based on the forward fusion object information. That is, the CPU determines whether a sufficient space for allowing the host vehicle HV to depart from the host lane HL is present.

In a case where the opposing lane OL is present, the CPU proceeds from S340 to S350. In a case where the host vehicle HV departs from the host lane HL to the opposing lane OL, the CPU determines whether the host vehicle HV is in a situation in which an opposing vehicle OV that inhibits the traveling of the host vehicle HV is not present, based on the forward fusion object information. Specifically, in a case where a time until the host vehicle HV reaches closest to the opposing vehicle OV is within a second time threshold value (for example, 8 seconds), the CPU determines that the opposing vehicle OV which inhibits the host vehicle HV from traveling during the lane departure to the opposing lane OL is present.

In a case where the opposing vehicle OV that inhibits the lane departure of the host vehicle HV is not present, the CPU proceeds from S350 to S360. The CPU determines whether the host vehicle HV is in a situation in which the other vehicle or the like (that is, an overtaking vehicle) that attempts to overtake the host vehicle HV is not present, based on rear fusion object information. Specifically, the CPU recognizes another vehicle or the like that is present behind the host vehicle HV and that is predicted to catch up with the host vehicle HV within a time that is predetermined as the overtaking vehicle.

In a case where an overtaking vehicle is not present, the CPU proceeds from S360 to S370 and determines whether the driver of the host vehicle HV is appropriately driving the host vehicle HV based on driver information. In a case where the driver of the host vehicle HV is performing distracted driving or drowsy driving or is unconscious, the CPU determines that the driver of the host vehicle HV is not appropriately driving the host vehicle HV.

In a case where the driver of the host vehicle HV is appropriately driving the host vehicle HV, the CPU proceeds from S370 to S380. The CPU determines whether the moving object is present in a nearby region of the target intersection (for example, a region within a radius that is predetermined (for example, 10 m) from a center point Q of the target intersection IS). In this case, the moving object is a pedestrian or the like or another vehicle or the like, but may be solely a pedestrian or the like. The determination in S380 is performed based on information indicating a position of the moving object acquired from the server 110 on the outside through communication. Further, the communication terminal CP carried by the pedestrian or the like and the communication device of the other vehicle transmit information for specifying a current position of each of the pedestrian or the like and the other vehicle to the server 110. Accordingly, the server 110 holds the information indicating the current positions.

In this case, the CPU may determine whether the moving object is present in a blind spot with respect to the host vehicle HV in the nearby region of the target intersection. Information indicating a range of the blind spot with respect to the host vehicle HV in the vicinity of the target intersection can be acquired from the current position of the vehicle and "map information stored in the map information storage device or information distributed from the server 110". In this case, a condition determined in S380 can be referred to as a first condition that is satisfied in a case where information indicating that the moving object is located in the blind spot with respect to the host vehicle HV is acquired.

Further, in S380, the CPU may also acquire information indicating a movement direction of the moving object present in the nearby region of the target intersection and determine whether the moving object is moving toward the host lane HL.

Further, in S380, the CPU may determine whether the moving object is reflected in a curb mirror (that is, a traffic mirror or a road mirror) installed in front of the host vehicle HV, based on the forward image data. Accordingly, the CPU can determine whether the moving object is present in the blind spot with respect to the host vehicle HV in the vicinity of the target intersection.

In a case where the moving object is present in the nearby region of the target intersection IS, the CPU proceeds from S380 to S390, sets the value of the lane departure allowance flag XP to "1", and proceeds to S395 to temporarily end the present routine. The fact that all the conditions of S320, S330, and S380 are satisfied means that a specific condition is satisfied. The specific condition is a condition that is satisfied when there is a possibility that the moving object suddenly jumps into the host lane from a blind spot with respect to the host vehicle HV.

On the other hand, in a case where the CPU determines "No" in any one of the steps of S310 to S380, the CPU directly proceeds to S395 from the step in which "No" is determined. The conditions determined in S320 and S330 (that is, the condition that is satisfied in a case where the lane width of the host lane is equal to or less than the lane width threshold value and the host vehicle HV is about to approach the target intersection that is an intersection having a blind spot) are also referred to as a "second condition" for convenience.

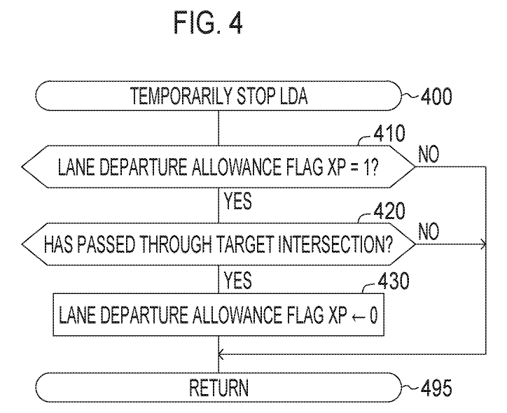

In a case where a timing that is predetermined is reached, the CPU starts processing from S400 of FIG. 4 to proceed to S410 and determines whether the value of the lane departure allowance flag XP is "1". In a case where the value of the lane departure allowance flag XP is "1", the CPU proceeds from S410 to S420 and determines whether the host vehicle HV has passed through the target intersection based on "the current position of the host vehicle HV and the map information". In a case where the host vehicle HV has passed through the target intersection, the CPU proceeds from S420 to S430 and sets the value of the lane departure allowance flag XP to "0". After that, the CPU proceeds to S495 to temporarily end the present routine. In a case where the CPU determines "No" in any one of the steps of S410 and S420, the CPU directly proceeds to S495 from the step in which "No" is determined.

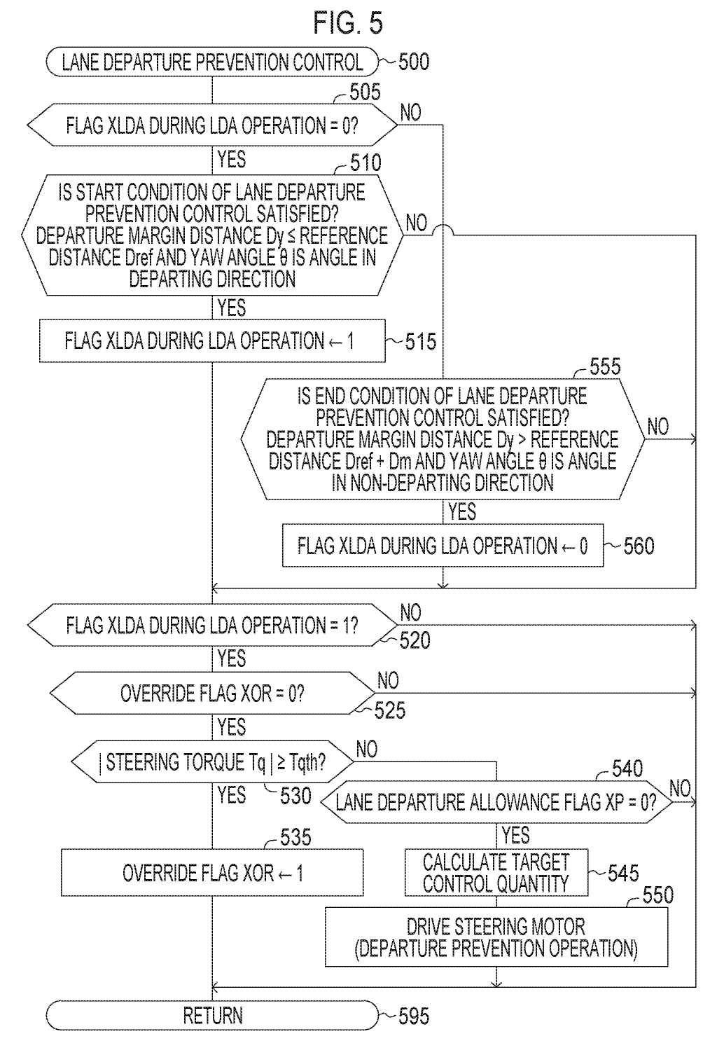

In a case where a timing that is predetermined is reached, the CPU starts processing from S500 of FIG. 5 to proceed to S505 and determines whether the value of a flag XLDA during LDA operation is "0". In a case where the value of the flag XLDA during the LDA operation is "0", the CPU proceeds from S505 to S510 and determines whether a start condition of the lane departure prevention operation is satisfied.

The start condition of the lane departure prevention operation is satisfied in a case where both the following condition 1 and condition 2 are satisfied (that is, in a case where it is predicted that the host vehicle HV departs from the host lane HL).

(Condition 1) A departure margin distance Dy is equal to or less than a reference distance Dref.

Condition 2 A yaw angle θ is an angle in a direction in which the host vehicle HV departs from the host lane HL beyond an approach boundary line. The approach boundary line is a boundary line closer to the host vehicle HV between the left boundary line LL and the right boundary line RL.

In a case where the start condition of the lane departure prevention operation is not satisfied, the CPU directly proceeds from S510 to S520. On the other hand, in a case where the start condition of the lane departure prevention operation is satisfied, the CPU proceeds from S510 to S515 and sets the value of the flag XLDA during the LDA operation to "1".

Next, the CPU proceeds to S520 and determines whether the value of the flag XLDA during the LDA operation is "1". In a case where the value of the flag XLDA during the LDA operation is "0", the CPU directly proceeds from S520 to S595 and temporarily ends the present routine. In this case, the lane departure prevention operation (automatic steering for lane departure prevention) is not performed.

On the other hand, in a case where the value of the flag XLDA during the LDA operation is "1", the CPU proceeds from S520 to S525 and determines whether the value of an override flag XOR is "0". In a case where the value of the override flag XOR is "1", the CPU directly proceeds from S525 to S595. In this case as well, the lane departure prevention operation is not performed.

On the other hand, in a case where the value of the override flag XOR is "0", the CPU proceeds from S525 to S530 and determines whether an absolute value of a steering torque Tq is equal to or greater than an override threshold value (OR threshold value) Tqth. In a case where the absolute value of the steering torque Tq is equal to or greater than the override threshold value Tqth, the CPU proceeds from S530 to S535, sets the value of the override flag XOR to "1", and proceeds to S595. In this case as well, the lane departure prevention operation is not performed. The value of the flag XOR is returned to "0" in a case where an override end condition that is predetermined is satisfied (for example, in a case where the host vehicle HV remains in the host lane HL for a certain time or longer).

On the other hand, in a case where the absolute value of the steering torque Tq is not equal to or greater than the threshold value Tqth, the CPU proceeds from S530 to S540 and determines whether the value of the lane departure allowance flag XP is "0".

In a case where the value of the lane departure allowance flag XP is "0", the CPU proceeds from S540 to S545 and obtains a target torque Tqtgt that is a target control quantity for lane departure prevention. The target torque Tqtgt is calculated to be a "value for causing the host vehicle HV to travel toward a centerline of the host lane HL". For example, in a case where the host vehicle HV departs to the left side from the left departure restriction line LD, the target torque Tqtgt is a value corresponding to a steering torque that causes the host vehicle HV to travel toward the right side. In a case where the host vehicle HV departs to the right side from the right departure restriction line RD, the target torque Tqtgt is a value corresponding to a steering torque that causes the host vehicle HV to travel toward the left side. Such a method of calculating the target torque Tqtgt is well known and is disclosed in Japanese Unexamined Patent Application Publication No. 2018-79835 (JP 2018-79835 A), Japanese Unexamined Patent Application Publication No. 2020-11562 (JP 2020-11562 A), and the like.

Next, the CPU proceeds to S550 and drives a steering motor 50 such that the steering motor 50 generates a steering assist torque matching the target torque Tqtgt. As a result, a "lane departure prevention operation" (that is, automatic steering for lane departure prevention) of preventing the host vehicle HV from departing from a departure restriction line on a departure side is performed. After that, the CPU proceeds to S595.

On the other hand, in a case where the value of the lane departure allowance flag XP is "1", the CPU directly proceeds from S540 to S595. Accordingly, in this case, the lane departure prevention operation is not performed. In other words, in a case where the value of the lane departure allowance flag XP is "1", the lane departure prevention control is temporarily stopped (interrupted).

Meanwhile, in a case where the CPU proceeds to S505 and the value of the flag XLDA during the LDA operation is "1", the CPU proceeds from S505 to S555 and determines whether an end condition of the lane departure prevention operation is satisfied.

The end condition of the lane departure prevention operation is satisfied in a case where both the following condition 3 and condition 4 are satisfied.

(Condition 3) The departure margin distance Dy is greater than a value obtained by adding a positive value Dm to the reference distance Dref.

(Condition 4) The yaw angle θ is an angle in a direction opposite to a direction in which the host vehicle HV departs from the host lane HL beyond the approach boundary line.

In a case where the end condition of the lane departure prevention operation is satisfied, the CPU proceeds from S555 to S560 and sets the value of the flag XLDA during the LDA operation to "0". After that, the CPU proceeds to S520. On the other hand, in a case where the end condition of the lane departure prevention operation is not satisfied, the CPU directly proceeds from S555 to S520.

As described above, in a case where the specific condition is satisfied, the specific condition being satisfied when there is a possibility that the moving object jumps into the host lane from outside the host lane (see the determination of "Yes" in each of S320, S330, and S380 and S390), the first device DS does not perform the lane departure prevention operation (S540: No). Accordingly, in a case where the driver recognizes that there is a high possibility that the moving object jumps into the host lane and performs steering such that the host vehicle HV departs from the host lane to a center side of the road, the lane departure prevention operation is suppressed (that is, stopped). Accordingly, it is difficult to inhibit such steering performed by the driver with the function of the lane departure prevention device.

### Second Embodiment

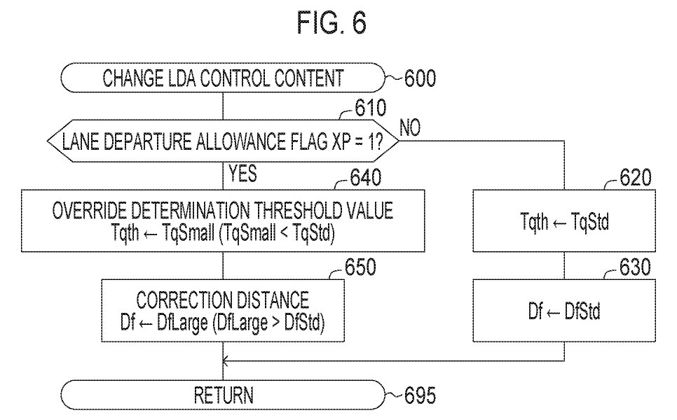

A "lane departure prevention device (hereinafter, referred to as a "second device")" according to a second embodiment of the present disclosure changes the override threshold value Tqth and the correction distance Df in a case where a specific condition is satisfied. That is, the CPU of the driving assistance ECU 10 of the second device is different from the CPU of the first device DS in that the CPU of the driving assistance ECU 10 of the second device executes a routine shown in FIG. 6 at time intervals that are predetermined, in addition to the flowcharts shown in FIGS. 3 to 5. In addition, in a case where the CPU of the second device determines "No" in S530 without performing the processing of S540 of FIG. 5, the CPU proceeds to S545.

In a case where a timing that is predetermined is reached, the CPU starts processing from S600 of FIG. 6 to proceed to S610 and determines whether the value of the lane departure allowance flag XP is "1".

In a case where the value of the lane departure allowance flag XP is "0", the CPU proceeds from S610 to S620 and sets the value of the override threshold value Tqth to a first value (standard value) TqStd. Next, the CPU proceeds to S630 and sets the value of the correction distance Df to a standard distance DfStd. After that, the CPU proceeds to S695 to temporarily end the present routine.

On the other hand, in a case where the value of the lane departure allowance flag XP is "1", the CPU proceeds from S610 to S640 and sets the value of the override threshold value Tqth to a second value TqSmall. The second value TqSmall is a value smaller than the first value TqStd. Next, the CPU proceeds to S650 and sets the value of the correction distance Df to an enlarged distance DfLarge. The enlarged distance DfLarge is a value greater than the standard distance DfStd. After that, the CPU proceeds to S695 to temporarily end the present routine.

As a result, in a case where the value of the lane departure allowance flag XP is "1" (that is, in a case where the specific condition is satisfied), the CPU is likely to determine "Yes" in S530 of FIG. 5. That is, in a case where the magnitude of the steering torque Tq of the driver reaches a value (second value TqSmall) smaller than the magnitude before the specific condition is satisfied, the override flag XOR is set to "1" (S535). Accordingly, the lane departure prevention operation is not performed (S525: No). Accordingly, in a case where the specific condition is satisfied, the lane departure prevention operation is suppressed.

Further, in a case where the value of the lane departure allowance flag XP is "1" (that is, in a case where the specific condition is satisfied), the correction distance Df is set to a value (that is, the enlarged distance DfLarge) greater than the value before the specific condition is satisfied. Accordingly, in a case where the specific condition is satisfied, the departure margin distance Dy (= Ds + Df) is also greater than the value in a case where the specific condition is not satisfied. As a result, the CPU is less likely to determine "Yes" in S510 of FIG. 5. In other words, in a case where the specific condition is satisfied, since the start condition of the lane departure prevention operation is changed to a condition that is more difficult to be satisfied, the lane departure prevention operation is not started until the host vehicle HV departs from the host lane HL by a greater distance. Accordingly, in a case where the specific condition is satisfied, the lane departure prevention operation is suppressed.

As described above, even with the second device, the driver may recognize that there is a high possibility that the moving object jumps into the host lane and may perform steering such that the host vehicle HV departs from the host lane to a center side of the road. In this case, the steering is less likely to be inhibited by the function of the lane departure prevention device.

The present disclosure is not limited to the embodiments described above and modifications, and various modifications can be employed within the scope of the present disclosure. For example, the present disclosure can be applied to a host vehicle in a state where a driving mode transitions from autonomous driving to driving by a driver in an autonomous vehicle.

The specific condition is determined to be satisfied in a case where all the determination conditions of S320, S330, and S380 are satisfied, but the determination condition of S330 is not indispensable. Further, at least one of the processing of S340 to S370 may be omitted from the routine shown in FIG. 3. The first device DS and the second device may include LiDAR as the vehicle peripheral sensor. The second device need not perform the processing of S630 and S650 or need not perform the processing of S620 and S640. Further, the target intersection in which determination is made whether the host vehicle has approached in S320 of FIG. 3 does not necessarily have a blind spot with respect to the host vehicle. Further, the specific condition may be a condition that is satisfied in a case where there is a possibility that the moving object suddenly jumps into the host lane, and the moving object before suddenly jumping into the host lane does not necessarily need to be located in a blind spot with respect to the host vehicle.

What is claimed is:

1. A lane departure prevention device comprising a controller configured to perform a lane departure prevention operation of automatically steering a steered wheel of a host vehicle such that the host vehicle does not depart from a host lane, when a start condition that is predetermined is satisfied, the start condition being satisfied when there is a possibility that the host vehicle departs from the host lane, wherein the controller is configured to suppress the lane departure prevention operation when a specific condition is satisfied, the specific condition being satisfied when there is a possibility that a moving object jumps out into the host lane from outside the host lane.

2. The lane departure prevention device according to claim 1, wherein the controller is configured to suppress the lane departure prevention operation by not performing the lane departure prevention operation when the specific condition is satisfied.

3. The lane departure prevention device according to claim 1, wherein the controller is configured to:
stop performing the lane departure prevention operation when a magnitude of a steering torque applied to a steering wheel by a driver of the host vehicle during the lane departure prevention operation is equal to or greater than an override threshold value; and
suppress the lane departure prevention operation by changing the override threshold value to a value smaller than a value before the specific condition is satisfied, when the specific condition is satisfied.

4. The lane departure prevention device according to claim 1, wherein the controller is configured to determine that the specific condition is satisfied when a first condition is satisfied, the first condition being satisfied when information indicating that the moving object is located outside the host lane and in a blind spot with respect to the host vehicle is acquired.

5. The lane departure prevention device according to claim 4, wherein the controller is configured to determine that the specific condition is satisfied when, in addition to the first condition, a second condition is satisfied, the second condition being satisfied when a lane width of the host lane is equal to or less than a lane width threshold value that is predetermined and the host vehicle is about to approach an intersection having the blind spot.
